(19) United States
(12) Patent Application Publication
(10) Pub. No.: US 2015/0120529 A1
(43) Pub. Date: Apr. 30, 2015

(54) DOOR ACCESS AND PACKAGE DELIVERY

(71) Applicant: Google Inc., Mountain View, CA (US)

(72) Inventor: Alexander Faaborg, Mountain View, CA (US)

(73) Assignee: Google Inc., Mountain View, CA (US)

(21) Appl. No.: 14/067,104

(22) Filed: Oct. 30, 2013

(51) Int. Cl. G06Q 10/08; G07C 9/00

(52) U.S. Cl. CPC G06Q 10/083; G07C 9/00047
USPC 705/39; 705/330

(57) ABSTRACT

Systems and techniques are disclosed for receiving a package identification code at a first location, the code corresponding to a delivery package. The package identification code may then be analyzed and a recipient authentication (e.g., a signature, a PIN code, etc.) may be requested from a user. Access to a portal may be granted based on receiving an acceptable recipient authentication code. The portal may be one of a plurality of portals, and may be selected based on the package identification code.

### BACKGROUND

Traditionally, a package for delivery is left at or near a recipient's door if the recipient does not grant access to a carrier employee delivering the package. For example, a carrier employee attempting to deliver a box to a user's home may ring the user's doorbell. The user may not be home or may not hear the doorbell and, thus, the carrier employee may leave the box outside the user's door. A package left at or near a recipient's door may be susceptible to damage via environmental conditions (e.g., rain, snow, ice, wind, etc.), traffic (e.g., foot traffic, pets, etc.), and may also be susceptible to theft. Automatically granting access to a user's residence without consulting with the user may not be desirable for various reasons such as security, theft, and the like.

A package for delivery often requires an in-person delivery, generally validated via a signature provided by a user that accepts delivery of the package. A package that requires a signature may be sent back to a carrier's warehouse or be sent back to a sender if a user is not available to accept the package and/or provide a signature.

### BRIEF SUMMARY

According to implementations of the disclosed subject matter, a package identification code corresponding to a delivery package may be received at a location. The package identification may be analyzed and a recipient authentication may be requested. The recipient authentication may be received based on a user input at a different location than the location where the package identification corresponding to a deliver package is received. The user input may be provided using a recipient user device. Access to a first portal may be provided based on the recipient authentication.

Systems and techniques according to the present disclosure allow access to a portal based on a recipient authentication provided by a user at a remote location. Additional features, advantages, and implementations of the disclosed subject matter may be set forth or apparent from consideration of the following detailed description, drawings, and claims. Moreover, it is to be understood that both the foregoing summary and the following detailed description include examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows a computer according to an implementation of the disclosed subject matter.

FIG. 2 shows a network configuration according to an implementation of the disclosed subject matter.

FIG. 3 shows an example process for providing access to a first portal, according to an implementation of the disclosed subject matter.

FIG. 4 shows an example illustration of package delivery, according to an implementation of the disclosed subject matter.

FIG. 5a shows an example illustration of a recipient device input, according to an implementation of the disclosed subject matter.

FIG. 5b shows another example illustration of a recipient device input, according to an implementation of the disclosed subject matter.

FIG. 5c shows an example illustration of a recipient device input, according to an implementation of the disclosed subject matter.

FIG. 6 shows another example process of providing access, according to an implementation of the disclosed subject matter.

FIG. 7 shows an example illustration of multiple portals, according to an implementation of the disclosed subject matter.

### DETAILED DESCRIPTION

Providing access to a portal for the delivery of a package may enable a user to receive a package at a location (e.g., a user's home, work, identified place of delivery, etc.) without physically being located at the location, to receive the package. According to implementations of the disclosed subject matter, a package identification code that corresponds to a delivery package may be received at a first location. The first location may be any applicable location such as a user's home, work, identified place for delivery, or the like. The package identification code may be any applicable code such as a machine readable code, a numerical value, an alphabetical code, an alphanumeric code, a barcode, QR code, or the like and may be received via any applicable technique such as image recognition (e.g., barcode scanner, QR code reader, etc.), user input, near field communication, radio-frequency identification, Bluetooth™, or the like. A recipient authentication may be requested prior to providing access to a portal. The recipient authentication may be any applicable authentication such as a signature, Personal Identification Number (PIN) code (which may include other elements besides numbers), user input (e.g., pressing a button, speaking a command, providing biometric data, or the like), a preprogrammed instruction, or the like. Access to a portal may be granted based on receiving an acceptable recipient authentication. For example a carrier employee may position a package such that a scanner next to a user's front door can scan a barcode on the package. The arrangement may determine that a user signature is required for this package and display a message on a user's mobile phone to provide a signature. The signature may be provided to the carrier service and an opening on the door may unlock to allow the employee to insert the package via the opening. According to implementations, analyzing the package identification code may also enable the arrangement to determine which one of two or more portals to provide access to. Additionally, a carrier authentication (e.g., a carrier employee's credentials) may be required prior to providing access to a portal.

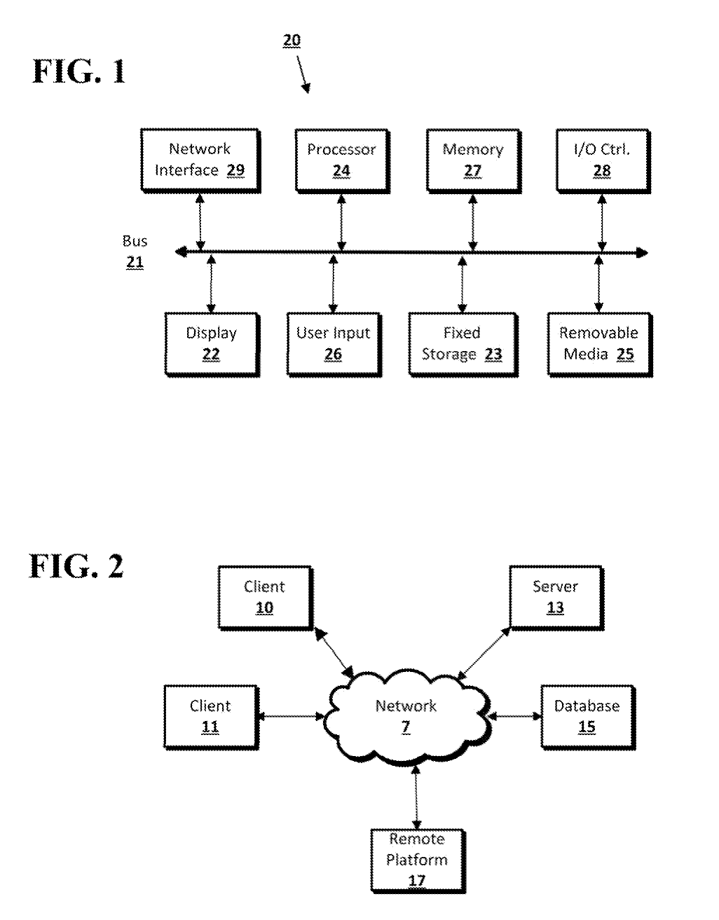

Implementations of the presently disclosed subject matter may be implemented in and used with a variety of component and network architectures. FIG. 1 is an example computer 20 suitable for implementing implementations of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display or touch screen via a display adapter, a user input interface 26, which may include one or more controllers and associated user input or devices such as a keyboard, mouse, WiFi/cellular radios, touchscreen, microphone/speakers and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM can include the main memory into which the operating system and application programs are loaded. The ROM or flash memory can contain, among other code, the Basic Input-Output system (BIOS) which controls basic hardware operation such as the interaction with peripheral components. Applications resident with the computer 20 can be stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 2.

Many other devices or components (not shown) may be connected or communicated with in a similar manner (e.g., document scanners, image scanners, Bluetooth™ device, digital cameras and so on). Conversely, all of the components shown in FIG. 1 need not be present to practice the present disclosure. The components can be interconnected in different ways from that shown. The operation of a computer such as that shown in FIG. 1 is readily known in the art and is not discussed in detail in this application. Code to implement the present disclosure can be stored in computer-readable storage media such as one or more of the memory 27, fixed storage 23, removable media 25, or on a remote storage location.

FIG. 2 shows an example network arrangement according to an implementation of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

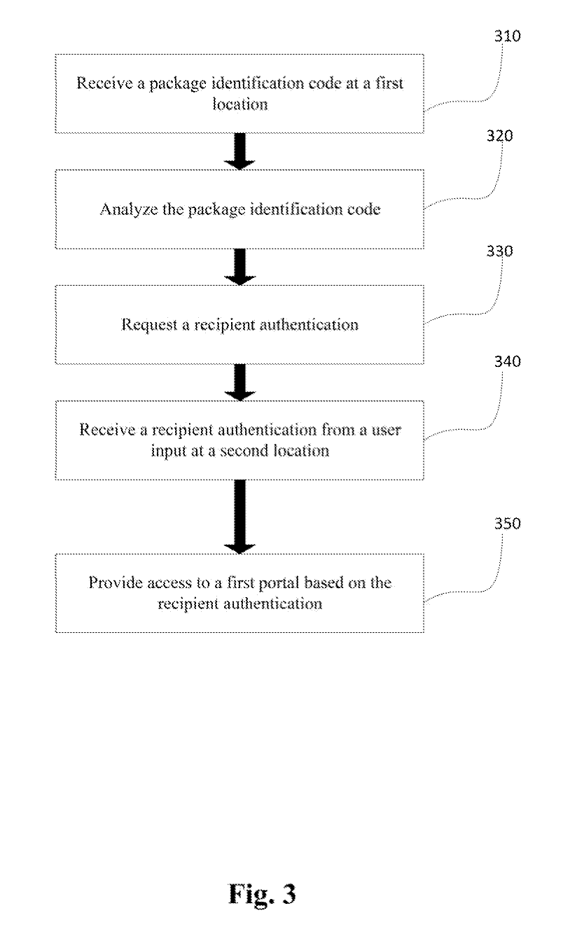

According to implementations of the disclosed subject matter, as shown in FIG. 3 at step 310, a package identification code may be received at a first location. The package identification code may be extracted from a package for delivery. The package identification code may be extracted via an image reading device such as a QR reader, barcode reader, computer image reader, or the like. The image reading device may be located at or near a delivery location. As an example, a box may be marked to be delivered to a user's home, as indicated by the user's home address on the box. The box may contain a barcode that can be scanned by a barcode scanner. A barcode scanner located at the user's home door may be configured to scan barcodes and may scan the barcode on the box when the box is positioned under the barcode scanner by a carrier employee delivering the box to the user's home. Alternatively, the package identification code may be a PIN code. The PIN code may be located on a delivery package or provided to a carrier separate from the delivery package. For example, a carrier employee may contain a list of PIN codes for all packages that the employee has to deliver. A PIN code may be any applicable code such as a numerical code, alphabetic code, alphanumeric code, or the like. The carrier may input a PIN code into a device configured to receive the PIN code such as a numerical pad, keyboard, or the like. Alternatively, the package identification code may be wirelessly transmitted from a package for delivery to a receiver. The transmission may be via any applicable protocol such as near field communication, radio-frequency identification, infrared, Bluetooth™, or the like. For example, a package may contain a radio-frequency identification chip within the package that communicates with a radio-frequency identification reader located on a user's home door.

As shown at step 320, a package identification code may be analyzed. The analysis may be conducted via any applicable computing entity such as a central processing unit, a computer, a database, a server, or the like. The analysis may occur locally such that the code is analyzed at a location proximate to where the package identification code was received. A local analysis may be conducted by a computing entity that is connected to a package identification code receiving device either via a wired or a wireless connection. For example, a barcode scanner configured to scan barcodes on packages for delivery at a user's home may have a wired connection to a central processing unit that is configured to receive and analyze a scanned barcode. Alternatively or in addition, the analysis may be conducted remotely such that the code or a representation of the code is transmitted to a remote computing entity. For example, a QR code scanner may be configured to scan QR codes on packages for delivery at a user's home may wirelessly transmit the QR code information scanned from a package to a satellite server. The satellite server may analyze the information contained within the QR code.

Analyzing a package identification code may include verifying the origin of the package, verifying the destination of the package, extracting a user identifier, extracting a user device identifier, determining what type of recipient authentication is required, determining a portal for which access is requested, or the like. As an example, a carrier employee may place a package under a barcode scanner such that the barcode scanner scans a package barcode. The scanned barcode may be converted to a numerical value and the numerical value may be sent to a remote server. The remote server may match the numerical value with an origin value and may authenticate the package based on the matching. More specifically, the remote server may determine that the user at whose home the barcode scanner is located is expecting a package from a sender associated with the identified origin value. Alternatively, the remote server may match the numerical value with a destination value and may match the destination value with the location of the barcode scanner that transmitted the numerical value to the remote server. More specifically, the remote server may verify that the package barcode is scanned by a scanner at the correct address. Alternatively, as disclosed herein, the remote server may identify and contact a user or user device based on the numerical value. More specifically, the numerical value may correspond to a user and/or user device and the remote server may contact the user and request a recipient authentication based on identifying the user and/or user device. It will be understood that although a numerical value is described as being extracted from a package identification code, any applicable identifier may be extracted, read, identified or generated based on the package identification code and may further be analyzed, transmitted, used to identify, or the like.

As shown at step 330, a recipient authentication may be requested. The recipient authentication may correspond to authorization by a user to allow access to a portal. A recipient authentication may be any applicable form of authentication such as selection of a respective button (e.g., a soft button, hard button, a button on a touch screen, etc.), inputting a PIN code (e.g., a numerical code, an alphabetical code, an alphanumeric code, a word, a sentence, etc.), providing biometric data (e.g., a fingerprint, a retina scan, a voice sample, etc.), a gesture, a command, a near field communication, or the like. A user or user device may be identified based on analyzing a package identification doe, as disclosed herein. Based on identifying the user or user device a computing entity may request a recipient authentication from the user.

At step 340, the recipient authentication request may be received by the arrangement. The recipient authentication request may be received by a remote entity or a local entity at or near the location where the package identification code was originally scanned. Either the remote or local entity may authorize access to a portal based on the recipient authentication code. For example, a remote server may receive the recipient authentication code and transmit a signal to a portal at a user's home. The signal may instruct a lock associated with the portal to unlock. A recipient authentication may be input via any applicable device such as a mobile device (e.g., mobile phone, tablet, laptop, keychain, watch, etc.), computing device (e.g., a desktop computer), or the like. As an example, a carrier employee may place a package under a barcode scanner such that the barcode scanner scans a package barcode. The scanned barcode may be converted to a numerical value and the numerical value may be sent to a remote server. The remote server may extract a user account form the numerical value and send a message to the mobile phone associated with the user account.

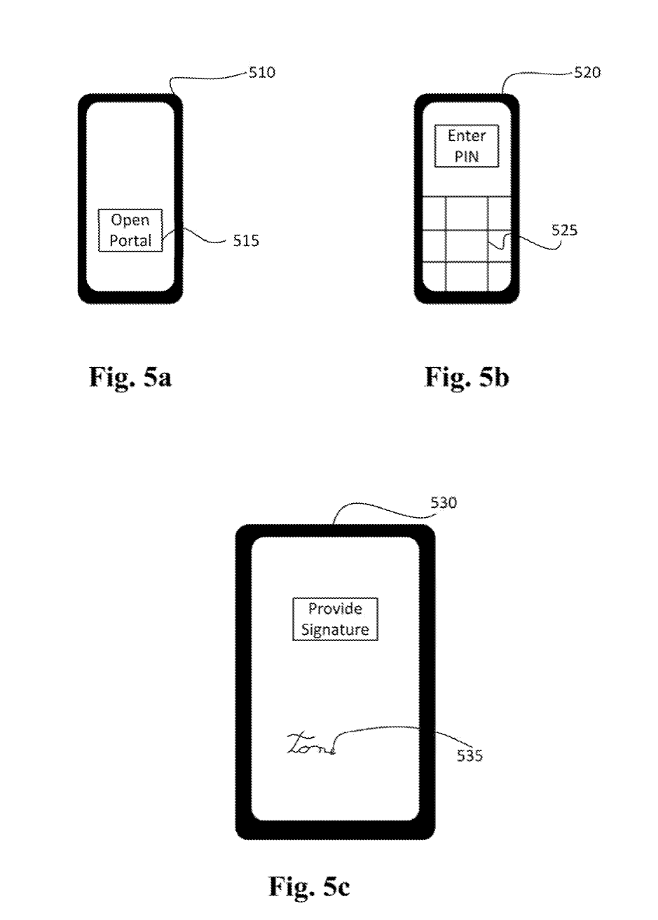

As an illustrative example, as shown in FIG. 5a, the message may be received by a user's touch screen enabled mobile phone 510 and contain a button 515, the button containing the words “Open Portal”, for the user to select. The user may select the button by touching the button on the touch screen. A selection of the button may result in the mobile phone 510 transmitting data to either a remote entity or an entity local to a location where a package identification code was originally received. Access to a portal may be granted based on the user selection of the button 515. Alternatively, as another illustrative example, as shown in FIG. 5b, the message may be received by a user's mobile phone 520 which contains a keypad 525. The message may require the user to input a PIN code using the keypad 525. The user may input the PIN code and the mobile phone 520 may transmit the inputted PIN code to either a remote entity or an entity local to a location where a package identification code was originally received. Access to a portal may be granted based on the inputted PIN code (e.g., if it matches a previously stored PIN code). Alternatively, as another illustrative example, as shown in FIG. 5c, the message may be received by a user's tablet 530 which enables the user to input a signature. The user may input a signature 535 via the tablet 530. The user input signature may be transmitted to a remote or local entity via the tablet 530. Access to a portal may be granted based on the signature.

As shown at step 350, access to a portal may be provided based on the recipient authentication code. As disclosed herein, the arrangement may determine if the recipient authentication code is valid and/or is sufficient to allow access to a portal. For example, a PIN code may be validated by the arrangement, and only a valid PIN code may result in providing access to a portal. Alternatively, as another example, receiving a signature from a user's mobile phone may also result in providing access to a portal. Access to a portal may include unlocking an area at or near a package destination address. As an example, if the package destination address is a user's home, then the portal may be a portion of the user's door that unlocks such that the package may be placed within that portion of the door. A portal may be an opening or a confined space. For example, a portal may be a portion of a door such that placing the package within the portion of the door results in placing the package into a room that can be accessed via the door. As another example, the portal may be a confined cube located adjacent to a door such that the package may be placed within the cube. Alternatively or in addition, providing access to a portal may be displaying an access code that may be input via an input device (e.g., keypad, keyboard, etc.) to open a portal. Alternatively or in addition, providing access to a portal may include unlocking and opening a portion of a portal to enable a package to be placed inside the portal.

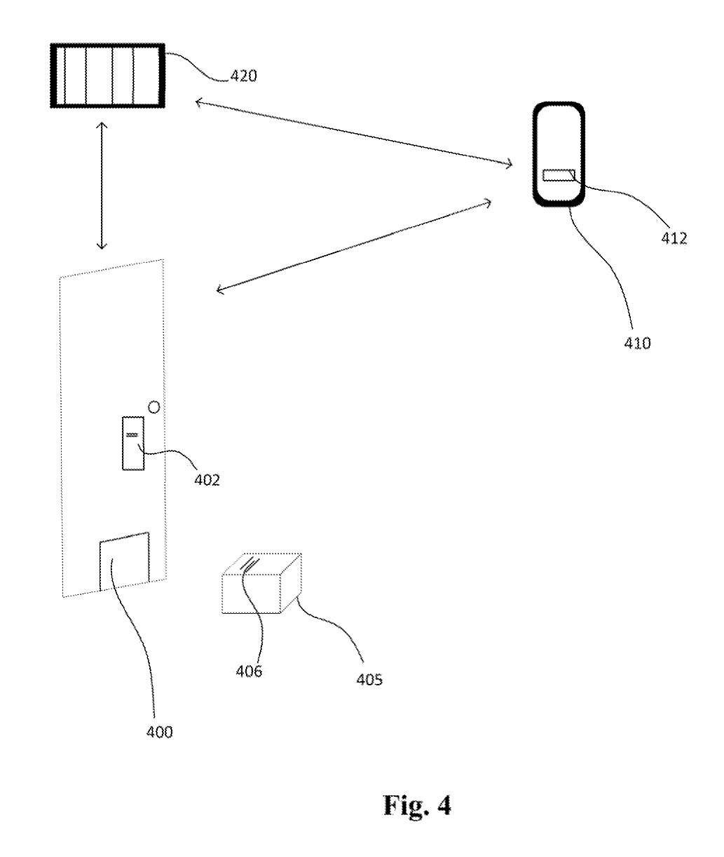

As an illustrative example, as shown in FIG. 4, a package 405 may contain a barcode 406. The barcode 406 may be scanned by barcode scanner 402 and the data gathered by the barcode reader 402 may be transmitted to a processor 420. The processor 420 may be local to the barcode scanner 402 (e.g., the communication is via a local connection such as a local area connection, a wired connection, a Wi-Fi connection, a Bluetooth™ connection, or the like) or may be remote from the barcode scanner 402 (e.g., the communication is via a remote connection such as a cellular connection, network connection, satellite connection, or the like). The processor 420 may analyze the barcode information and determine that the package is intended for a user whose account is associated with user device 410. The processor 420 may transmit a message to user device 410 and require the user to press button 412 to grant access to a portal. The user may press the button 412 and the user device 410 may transmit selection information to either the processor 420 or any other applicable device capable of providing access to portal 400. The processor 420 or other applicable device may cause the portal 400 to unlock such that a carrier employee may place the package 405 through the portal 400.

Notably, a package may be delivered to a first location (e.g., a user's home) while a user is located at a second remote location (e.g., the user's work). Thus, according to implementations of the disclosed subject matter, a user may securely receive a package while being remote from the location where the package is delivered. It will be understood that, as described herein, a remote or second location does not necessary infer the remote or second location being a minimum distance away from a first or local location. A remote or second location may simply be a location from which a user does not physically open or unlock a portal. For example, a package may be delivered to a user's front home door while the user is in the kitchen. Essentially, the user may accept the package without opening the door, while the user is within the user's home.

According to an implementation of the disclosed subject matter, two or more portals may be available to receive a package. A location may contain two or more portals for any applicable reason such as to accept packages of varying sizes, to accept packages that require special conditions, to accept multiple packages, or the like). A first portal may be selected over a second portal for any applicable reason such as if the package exceeds a threshold volume, dimension, and/or area. A special portal may be a portal that is configured to accept packages that require a special condition such as air-conditioning, heat, certain light, ventilation, or the like. A package identification code may contain or be associated with information that indicates a special condition. For example, the package identification code may be transmitted to a server and the server may match the code with a package that requires refrigeration. The arrangement may provide access to a portal based on determining a property or requirement associated with a package. Continuing the previous example, based on determining that the package requires refrigeration, the arrangement may provide access to a portal that is air-conditioned instead of a portal that does not air-conditioned.

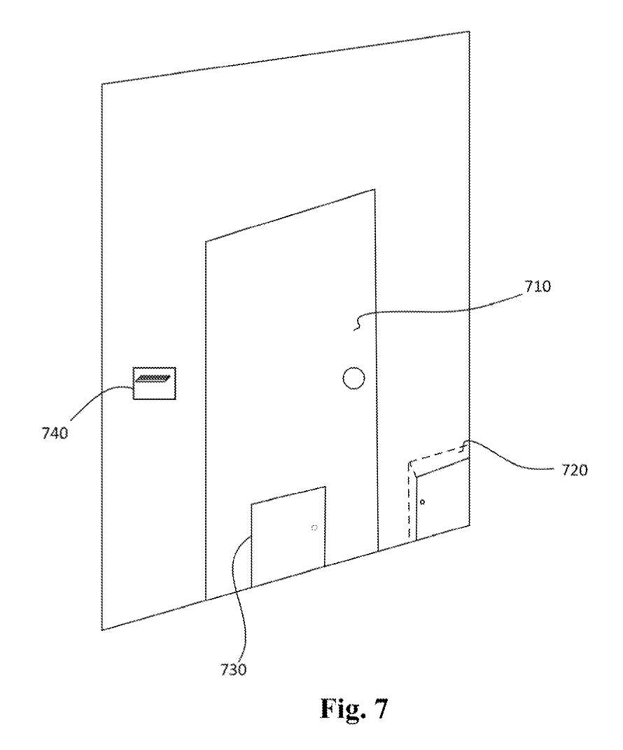

In an illustrative example of the disclosed subject matter, as shown in FIG. 7, a carrier employee (not shown) may place a package (not shown) under a barcode reader 740. The barcode reader may scan a barcode located on the package and extract a binary numerical number from the package. The barcode scanner 740 may transmit the binary numerical number to a remote server (not shown) and the remote server may extract user mobile phone information as well as special portal information from the binary numerical number. Accordingly, the remote server may request the corresponding user to provide a signature via the user's mobile phone. Upon receipt of the signature the remote server may instruct a ventilated portal 720 located adjacent to the user's home door to unlock based on the special portal information and successful receipt of the signature. A second carrier employee (not shown) may place a second package (not shown) under the barcode reader 740. The barcode reader 740 may scan a barcode located on the package and extract a binary numerical number from the package. A processor associated with the barcode reader 740 may analyze the binary numerical number and determine that portal 730 is sufficient to receive the second package. The processor may also request a user to provide fingerprint authentication via the user's mobile phone. Upon receiving valid fingerprint authentication, the processor may send a signal to portal 730 and portal 730 may unlock based on the signal. A third carrier employee (not shown) may place a third package (not shown) under the barcode reader 740. The barcode reader 740 may scan a barcode located on the package and extract a binary numerical number from the package. A processor associated with the barcode reader 740 may analyze the binary numerical number and determine that the package is larger than both portals 730 and 720 based on a portion of the binary numerical number. The processor may also determine that a portion of the binary numerical number is associated with a package that requires ventilation. Accordingly, upon receiving valid recipient authentication, as disclosed herein, portal 710 (i.e., the door) may unlock for the package to be placed inside the ventilated home.

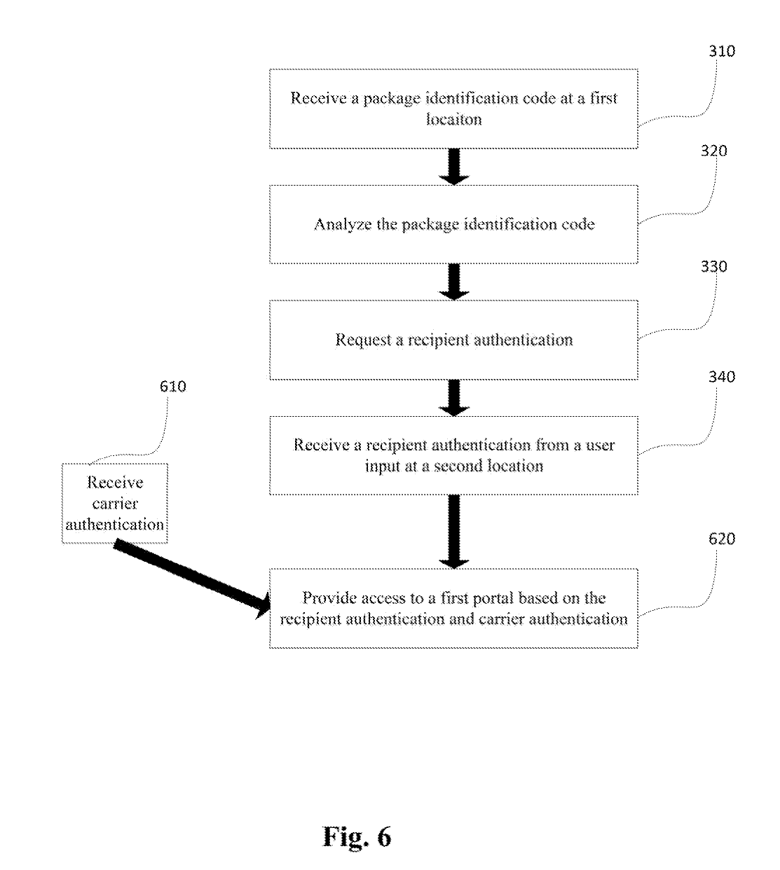

According to an implementation of the disclosed subject matter, as shown in FIG. 6, at step 610, the arrangement may receive carrier authentication. Carrier authentication may be any applicable authentication such a carrier employee's identification, a radio frequency identification input, a near field communication input, a numerical value, an alphanumeric value, biometric data, or the like. The carrier authentication may identify a carrier, a carrier employee, or both. As an example, a carrier employee that is delivering a package may configure the package to provide package identification code and, in addition, scan a radio frequency identification enabled badge that transmits the carrier employee's credentials to a radio frequency identification enabled receiver. At step 620, the receiver may utilize the carrier authentication information to determine whether access to a portal should be provided. As an example, a package barcode may be scanned by a barcode scanner located outside a user's home. The barcode information may contain user device identification information and a user may receive a message to input a PIN code on the user's device. A valid PIN code may be input by the user and the arrangement may request the carrier employee located at the user's home to input an employee number into a number pad. An invalid employee number input may result in no access to a portal and a valid employee number input may result in the arrangement providing access to a portal.

According to an implementation of the disclosed subject matter, a user may be provided with a media feed when a recipient authentication is requested. The media feed is any applicable feed such as a video feed, an audio feed, a text feed, or the like. As an example, a carrier employee may position a package such that a radio-frequency reader receives information from a radio-frequency transmitter and the arrangement requests a signature from a user prior to providing access to a portal. The user may also receive a live video feed from a video camera placed near the radio-frequency reader such that the user is able to view the carrier employee and/or the package containing the radio-frequency transmitter. Notably, the user may more confidentially provide a recipient authentication if the user can view a carrier employee, package, and/or a portal being accessed and then secured (e.g., closed, locked, etc.).

According to an implementation of the disclosed subject matter, a payment action may be activated based on receiving a recipient authentication request. The payment action may include authorizing a user payment prior to providing access to a portal. Authorizing a payment may include any applicable action such as instructing a financial institution (e.g., a credit card company, a bank, etc.) to initiate transfer of payment to a seller, removing a payment block, or the like. Alternatively or in addition, the payment action may include transferring funds to a seller such as via a wire transfer, an e-commerce provider, or the like. As an example, a user may purchase a product from a seller and provide credit card information for the payment of the product. However, payment for the product may be blocked until the user provides recipient authentication information for the delivery of the package. Essentially, a payment may not be made until an actual delivery has been made, allowing a buyer to ensure that a product is physically delivered prior to exchanging funds.

According to an implementation of the disclosed subject matter, the arrangement may calculate a duration for which a portal is accessible. The calculation may be based on how long a portal is open or unlocked. Further, the arrangement may activate an alarm if the calculated duration for how long the portal is accessible exceeds a threshold value. An alarm may include any applicable action such as activating audio or video output (e.g., a sound via a speaker and/or a light via a light emitter), alerting a user via any applicable manner such as via a phone call, a text message (e.g., an SMS message, an email, a notification, etc.), alerting the police or other security entity, alerting a carrier, or the like. A threshold value may be calculated by any applicable technique by a user, a manufacturer, or dynamically based on historical data. As an example, access to a user's home via a doorway portal may be granted by a user providing a recipient authentication request. The arrangement may calculate that the doorway is ajar for over 15 seconds, which exceeds a 10 second threshold time set by the manufacturer. Accordingly, the arrangement may send an SMS message to the user, alerting the user of the disturbance and may also alert a local police station regarding the disturbance.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method comprising:
receiving a package identification code, corresponding to delivery package, at a first location;
analyzing the package identification code;
requesting a recipient authentication;
receiving the recipient authentication wherein the recipient authentication comprises a user input at a second location, the second location remote from the first location;
providing access to a first portal based at least on receiving the recipient authentication.

2. The method of claim 1, wherein the package identification code is located on the delivery package.

3. The method of claim 1, wherein the package identification code is transmitted to a server after being received.

4. The method of claim 3, wherein the package identification code is analyzed by the server.

5. The method of claim 1, wherein the package identification code is analyzed by a computing device located at the first location.

6. The method of claim 1, wherein analyzing the package identification code comprises identifying a recipient user.

7. The method of claim 6, further comprising:
identifying a recipient user device based on the package identification code; and
requesting the recipient authentication by communicating with the recipient user device.

8. The method of claim 1, wherein the recipient authentication is the user input of a user signature.

9. The method of claim 1, wherein the recipient authentication is a user input selected from the group consisting of: a selection of a button, a gesture, a command, a near field communication input, and a biometric input.

10. The method of claim 1, wherein the recipient authentication is a user input using a mobile device located at the second location.

11. The method of claim 1, wherein the recipient authentication is a user input personal identification number.

12. The method of claim 1, further comprising providing a media feed to a user, the media feed selected form the group consisting of: a video feed, an audio feed, and a text feed.

13. The method of claim 1, wherein providing access to the first portal further comprises:
receiving a carrier authentication; and
providing access to the first portal based at least on receiving the carrier authentication.

14. The method of claim 1, further comprising authorizing a user payment prior to providing access to the first portal.

15. The method of claim 1, further comprising authorizing a transferring of funds to a seller prior to providing access to the first portal.

16. The method of claim 1, further comprising:
calculating a duration for which the first portal is accessible; and
activating an alarm if the calculated duration exceeds a threshold value.

17. The method of claim 1, wherein analyzing the package identification code further comprises:
determining that the delivery package exceeds a threshold space; and
providing access to a second portal based on determining that the delivery package exceeds the threshold space.

18. The method of claim 17, wherein the threshold space is selected from the group consisting of: a volume, a dimension, and an area.

19. The method of claim 1, wherein analyzing the package identification code further comprises:
determining that the delivery package qualifies as a special delivery package; and
providing access to a special portal based on determining that the delivery package exceeds the threshold space.

20. The method of claim 19, wherein the special portal is selected form the group consisting of: an air-conditioned portal, a heated portal, a light controlled portal, and a ventilated portal.
